(19) United States
(12) Patent Application Publication
(10) Pub. No.: US 2013/0051971 A1
(43) Pub. Date: Feb. 28, 2013

(54) Expandable Stowable Platform for Unloading Trucks

(71) Applicants: Gene Wyse, Wauseon, OH (US); Randy Gene Wyse, Wauseon, OH (US)

(72) Inventors: Gene Wyse, Wauseon, OH (US); Randy Gene Wyse, Wauseon, OH (US)

(21) Appl. No.: 13/597,649

(22) Filed: Aug. 29, 2012

Related U.S. Application Data
(60) Provisional application No. 61/528,595, filed on Aug. 29, 2011.

(51) Int. Cl. B62D 25/00; B60P 1/43

(52) U.S. Cl. 414/812; 280/762

(57) ABSTRACT

A stowable platform for side access doors of trailers for commercial trucks is provided. The platform is designed to compactly fit into a storage cavity built into the trailer. This cavity can be underneath the floor of the vehicle. The platform is designed to slide out from its storage cavity and be positioned against the vehicle to provide side access to the vehicle. After removal from storage, the platform can be expanded to a much more convenient size for loading or unloading of the vehicle.

### CROSS REFERENCE TO RELATED APPLICATION

This application claims the benefit of provisional application U.S. 61/528,595 filed Aug. 29, 2011. US 61/528,595 was pending as of the filing date of this application.

### BACKGROUND OF THE INVENTION

1. Field of the Invention

The present invention relates to platform for a truck, specifically a commercial delivery truck, for ease of unloading from side doors on the truck. The platform is stowable underneath the vehicle and expandable to provide more working space for those unloading the truck.

2. Summary of Related Art

Side platforms for commercial delivery vehicles are commonly used to facilitate moving, loading, and unloading items from the vehicle. This is especially true in the refrigerated vehicle industry, (typically food transporting vehicles) wherein it has become common to provide multiple regions within a single truck, wherein one region can accommodate frozen products, and another can accommodate refrigerated products, and even in cases an additional non-refrigerated section for products which can be stored at room temperature. Access to these sections which are not at the rear of the trailer is typically provided through side doors on the trailer. In order to facilitate access to these side doors, it is known to provide a removable access platform, adjacent to the door, to which an unloading ramp can be attached. It is common for the same ramp which can be used with the primary rear door of the vehicle to be attachable to this platform, allowing the ramp to then be parallel to the side of the vehicle minimizing space needed for unloading from this side door.

Known platforms generally come in one of two types. A first known type of side access platform directly slides into storage underneath the trailer. A safety rail can be attached to these platforms which is flipped up upon removal of the platform and safety ropes can be connected from this platform to the side of the truck. A second known type of platform can generally be stored in sections underneath the vehicle. When use of the platform is required, the operator can remove the platform sections and assemble them adjacent to the unloading door of the trailer.

One drawback of the known ramps is that the platform is typically very limited in size due to the storage requirements. The storage regions underneath the vehicle can be limited in width due to structural concerns with the trailers. For platforms that are stored in a single piece, they are limited to the width of the storage area which can safely be provided underneath the trailer. Otherwise, the platforms must be assembled and disassembled at each use. The limited size of the platform can raise significant safety concerns. If the vehicle is being unloaded, bulky, relatively heavy objects are often being unloaded from the side of the vehicle. Often the individual unloading the vehicle will step out the side of the vehicle onto the platform and will need to execute a 90 degree turn to move safely down the loading ramp. Depending on the bulkiness of the cargo, this can be difficult and dangerous to execute such a turn on a relatively small platform.

### SUMMARY OF THE INVENTION

According to the present invention, there is stowable side platform, designed to be stowed in a standard storage space underneath a trailer. The platform, when extracted from underneath the trailer is designed in an expandable manner, so that a much larger surface area can be provided on the platform. This expandable platform is provided as a single constructed piece, so that no parts must be individually removed and assembled by the operator. The platform can be extracted and then expanded with no additional assembly required. A ramp can safely be attached to this expanded platform for removal of goods from the trailer.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 shows a view of an embodiment of the platform according to the present invention with the sides extended.

FIG. 2A shows a downward looking view of the present invention with the safety rail in the down position.

FIG. 2B shows the view of FIG. 2A with the safety rail in the upright position.

FIG. 2C shows the view of FIG. 2B with the sides extended.

FIGS. 3A-3C shows side views of the embodiment of the invention shown in FIGS. 2A-2C.

FIGS. 4A-4C show end views of the embodiment shown in FIGS. 2A-2C.

### DESCRIPTION OF THE PREFERRED EMBODIMENT

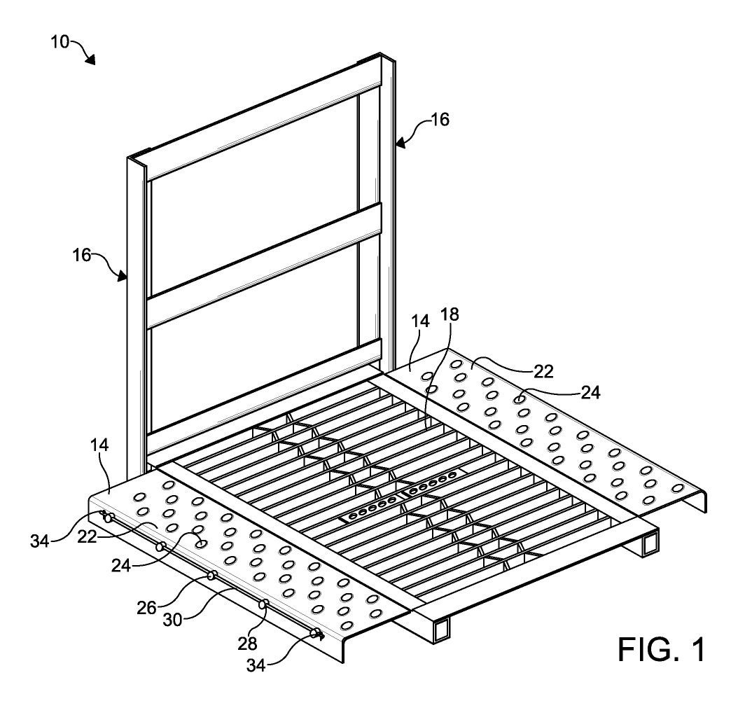

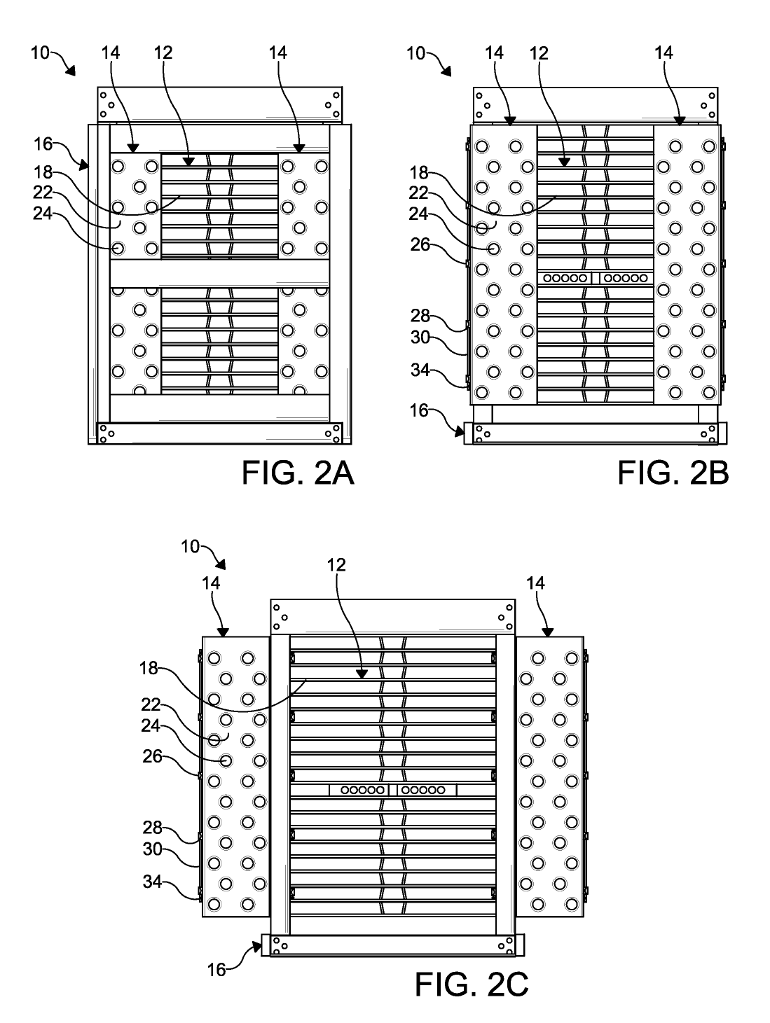

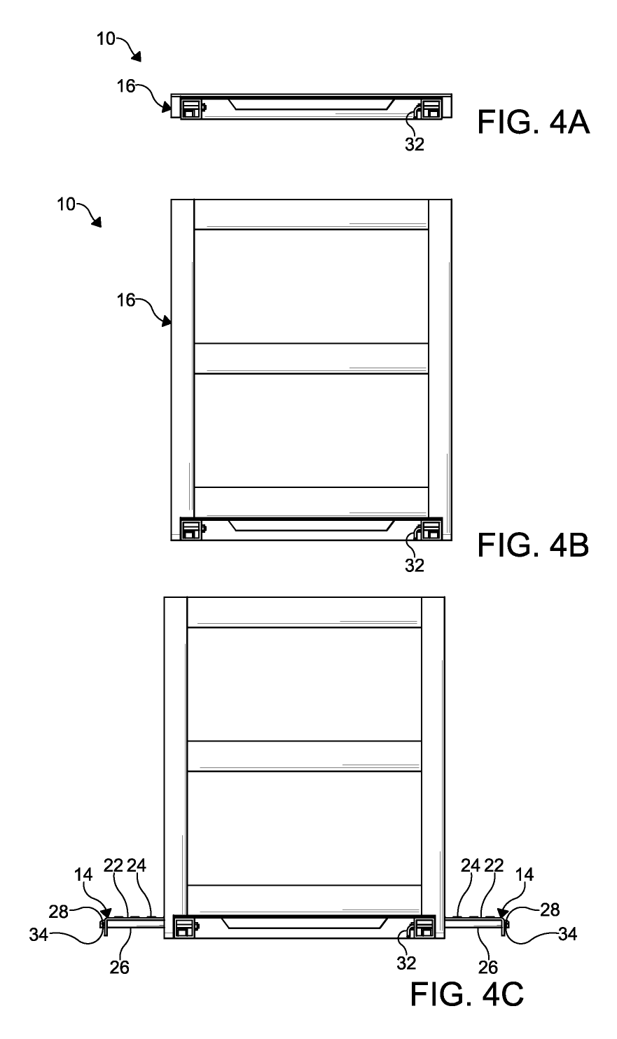

FIG. 1 shows a preferred embodiment of the present invention. Platform 10 comprises a center section 12 (see FIG. 2A-2C), with two expansion wings 14. The expansion wings are designed to provide a larger operating surface when the platform is extended. A safety rail 16 is disposed over the platform for storage when it is in its compressed state, and is flipped upwards when the platform is being opened for use. The safety rail can pivot by any number of known pivoting means. A release mechanism 32 (see FIGS. 4A, 4B, 4C) can release this safety rail from its upright position. The release mechanism can take any form known in the art, but in a preferred embodiment comprises a handle with a ping which slides out to unlock the safety rail.

The center section of the platform can take on numerous types of construction, but in a preferred embodiment of the present invention takes the form of cross pieces 18 with supports 20. These cross pieces and supports provide adequate footing for a user standing on the platform and also provide structural support to this center section 12.

The expansion wings can be of different construction types, but in a preferred embodiment of the present invention each comprise a primary surface 22 with holes 24. The holes serve to provide extra traction for a user standing on the platform, and in addition can be used to receive hooks from a ramp (not pictured) to affix a ramp to the platform. Such a design can be especially valuable in inclement weather situations, where a user's footwear can become covered with ice or snow which can be dislodged by these holes in the expansion wings 14.

In a preferred embodiment, the expansion wings 14 can be connected to the center section 12 by a series of support bars 26, running underneath the surface of the wing sections. The support bars can have holes 28, on both the inner and outer ends of the bars, which in this embodiment can be held on the inner end by cotter pins 34 and on the outer end by a connecting rod 30 disposed through them. This embodiment is advantageous in that the connecting rod 30 will hold the support bars 26 in position relative to the other bars. The connecting rod can be secured at its ends by conventional means, in this embodiment by pins through the ends of connecting rods 30.

FIG. 1 shows the platform with the safety rail 16 upright with both expansion wings 14 extended. FIG. 2A, 3A and 4A show the safety rail 16 lowered over the platform and the wings thus retracted. This would be the position the platform would be in for placement in storage underneath the vehicle trailer.

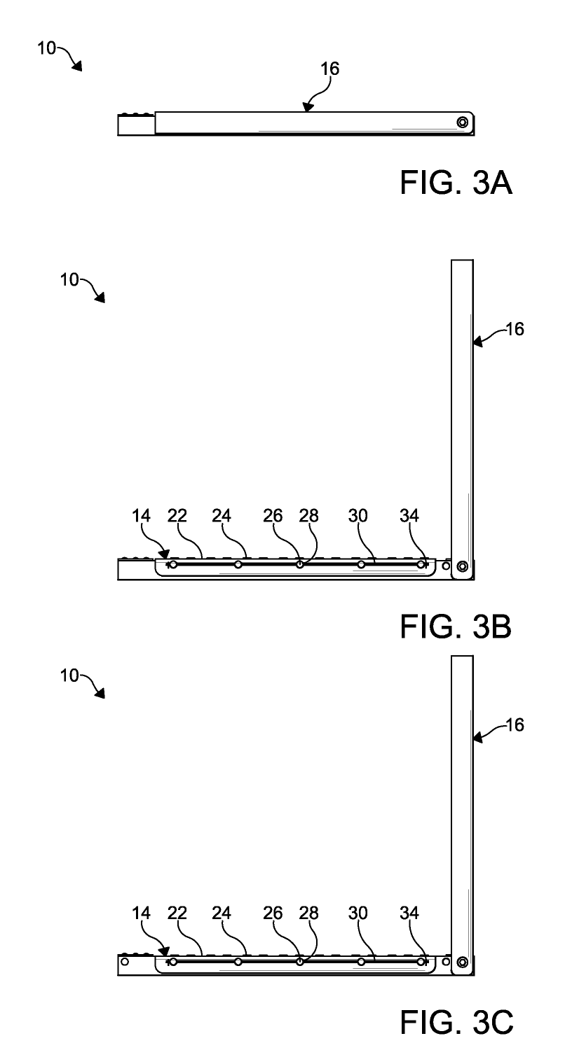

FIGS. 2B, 3B and 4B show the platform with the safety rail raised, but the wings still in their stowed or retracted position.

It should be noted that the construction shown allows for a substantially flat surface between the expansion wing 14 and the center section 12 when the wing is extended. This is advantageous in that it minimizes “bumps” that someone unloading the trailer would need to move over when unloading.

FIGS. 2C, 3C and 4C show a view of the platform with the wings extended and the safety rail upright. While the platform could be used with the wings retracted, it is preferred that in operation the wings be fully extended to provide the maximum surface for operation, as is shown in these drawings.

With the design shown in this embodiment, it should be noted that the expansion wings can nearly double the size of the platform from the surface area of the center section alone. For a user maneuvering a cart out of the trailer, this can provide substantially more room to maneuver for both a convenience, and more importantly a safety aspect.

In a preferred embodiment of the present invention, when fully compacted the platform can fit into a slot that measures 34½ inches by 3½ inches. This size can be especially beneficial in that it can fit in certain standardized slots beneath the trailers.

In an additional preferred embodiment, the expandable wings can be designed so that they do not extend fully adjacent to the body of the trailer when the platform is extended from the trailer and the wings are expanded. This can be advantageous in that it can accommodate doors extending either forward or backward (pivoting left or right) when opened.

In preferred embodiments of the present invention the platform can comprise aluminum. Other materials can be envisioned within the scope of the present invention.

While the safety rail is present in preferred embodiments of the present invention, other embodiments without this fixed safety rail may be envisioned.

When using the invention, after opening the trailer door to be accessed, the operator would start by extracting the fully compressed platform from underneath the vehicle trailer. A standard stop mechanism can be provided that does not allow the user to extend the platform past its operable position. Conventional means can be used to secure the platform to the vehicle. Once the platform is extended, the operator would release the safety rail and lift it to its upright position. Then, the operator would grab and lift the inside of one of the expansion wings and then extend it outward until it reaches its maximum extension and then drop it into place. While the platform could be useable with neither or only one side extended, generally the operator will then lift and pull the other side to extend the platform to its maximum size. At this point the platform is ready for use. The ramp can be positioned adjacent and parallel to the vehicle, and attached to the platform, preferably by latching it to the holes in the expansion wings. Additional safety ropes can be connected, if desired, from the safety rail to the sides of the vehicle on the side of the platform where unloading is not taking place.

Subsequent to the loading/unloading of the vehicle, the steps can be reversed and the platform can be returned to its storage position under the vehicle.

Embodiments of the present invention can be provided as original vehicle equipment, or can be subsequently retrofit for use with the vehicle trailer.

1. A stowable side platform for commercial vehicles comprising:
a center section;
a pair of expansion wings, said expansion wings being slidably connected to said center section;
each of said center wings being configured to extend in opposite directions from said center section;
a safety rail, said safety rail being pivotably connected to said center section and being disposed between said expansion wings;
each of said expansion wings comprising a locking mechanism, said locking mechanisms being designed to slidably connect said expansion wings to said center section; wherein
said platform is configured to be disposed in a storage area underneath a commercial vehicle when said platform is not in use; and
said platform is configured to be removable from underneath a commercial vehicle and expanded to a larger size for loading and unloading the commercial vehicle.

2. The platform according to claim 1, wherein the platform is made of aluminum.

3. The platform according to claim 1, wherein the center section comprises a series of support braces for a user to stand on.

4. The platform according to claim 1, wherein the expansion wings comprise a metal plate with holes disposed therein.

5. The platform according to claim 1, wherein the safety rail comprises a second locking mechanism to hold said rail in the upright position.

6. The platform according to claim 5, wherein the second locking mechanism comprises a release handle to release said locking mechanism.

7. The platform according to claim 1, wherein the expansion wings form a substantially flat surface with the center section when fully extended.

8. The platform according to claim 7, wherein each of the expansion wings are less than half of the width of the center section, so that when retracted they do not overlap.

9. A method for unloading a commercial vehicle through a side door with a stowable platform, the platform comprising a center section, with expandable wings attached to opposing sides of the center section and a safety rail attached to the center section on an end between the expandable wings, the method comprising:
retracting the stowable ramp from under the vehicle and securing it to the vehicle adjacent to a side door of the vehicle;
lifting the safety rail from the center section and locking it in an upright position relative to the center section;
expanding the expansion wings to extend with width of the platform; and
attaching a ramp to the platform to provide a surface connecting the ramp to the ground for unloading the vehicle.
